(19) United States
(12) Patent Application Publication
(10) Pub. No.: US 2016/0328765 A1
(43) Pub. Date: Nov. 10, 2016

(54) ENHANCED SUPPLY AND DEMAND TOOL

(71) Applicant: eBay Inc., San Jose, CA (US)

(72) Inventors: Wilson Pang, San Jose, CA (US); James Lane, San Jose, CA (US); Jaime Colmenares, San Francisco, CA (US); Uwe F. Mayer, Encinitas, CA (US); Gyanit Singh, San Jose, CA (US); Ravi Tiwari, San Jose, CA (US); Peter Andrew Coles, Campbell, CA (US); Dominic Coey, Palo Alto, CA (US)

(21) Appl. No.: 15/149,964

(22) Filed: May 9, 2016

Related U.S. Application Data
(60) Provisional application No. 62/159,052, filed on May 8, 2015.

(51) Int. Cl. G06Q 30/06

(52) U.S. Cl. CPC G06Q 30/0605; G06Q 30/0641; G06Q 30/0631

(57) ABSTRACT

A comparison between items for sale in a marketplace and items for sale at an external retailer is used to generate one or more recommended actions for the marketplace. For example, if the marketplace has a comparable quantity of available items in a product cluster with better prices, a recommendation to promote the items based on price may be generated As another example, if the marketplace has a better variety of items available in the product cluster, a recommendation to promote the items that are unavailable at the external retailer may be generated. As a third example, if the marketplace has fewer items available in the product cluster, a recommendation to procure additional inventory may be generated. As yet another example, if the marketplace has items available in the product cluster at a higher price than the external retailer, a recommendation to reduce prices may be generated.

### PRIORITY CLAIM

The application claims priority to U.S. Provisional Patent Application No. 62/159,052, filed May 8, 2015, entitled “Enhanced Supply and Demand Tool,” which is incorporated herein by reference in its entirety.

### TECHNICAL FIELD

Embodiments of the present disclosure relate generally to data processing and, more particularly, but not by way of limitation, to an enhanced supply and demand tool.

### BACKGROUND

Conventionally, supply and demand tools monitor a current inventory in comparison with a desired inventory to generate suggestions such as ordering additional inventory if the current inventory is low or to reduce prices if the current inventory is high.

### BRIEF DESCRIPTION OF THE DRAWINGS

Various ones of the appended drawings merely illustrate example embodiments of the present disclosure and cannot be considered as limiting its scope.

FIG. 1 is a block diagram illustrating a networked system suitable for implementing an enhanced supply and demand tool, according to some example embodiments.

FIG. 2 is a block diagram illustrating modules of a computer system suitable for implementing an enhanced supply and demand tool, according to some example embodiments.

FIG. 3 is a flow diagram illustrating operations of a computer system suitable for implementing an enhanced supply and demand tool, according to some example embodiments.

FIG. 4 is a flow diagram illustrating operations of a computer system suitable for implementing an enhanced supply and demand tool, according to some example embodiments.

FIG. 5 is a flow diagram illustrating operations of a computer system suitable for implementing an enhanced supply and demand tool, according to some example embodiments.

FIG. 6 is a flow diagram illustrating operations of a computer system suitable for implementing an enhanced supply and demand tool, according to some example embodiments.

FIG. 7 is an interface diagram illustrating a user interface for an enhanced supply and demand tool, according to some example embodiments.

FIG. 8 is a block diagram illustrating an example of a software architecture suitable for implementing an enhanced supply and demand tool that may be installed on a machine, according to some example embodiments.

FIG. 9 illustrates a diagrammatic representation of a machine in the form of a computer system within which a set of instructions may be executed for causing the machine to implement an enhanced supply and demand tool, according to an example embodiment.

The headings provided herein are merely for convenience and do not necessarily affect the scope or meaning of the terms used.

### DETAILED DESCRIPTION

The description that follows includes systems, methods, techniques, instruction sequences, and computing machine program products that embody illustrative embodiments of the disclosure. In the following description, for the purposes of explanation, numerous specific details are set forth in order to provide an understanding of various embodiments of the inventive subject matter. It will be evident, however, to those skilled in the art, that embodiments of the inventive subject matter may be practiced without these specific details. In general, well-known instruction instances, protocols, structures, and techniques are not necessarily shown in detail.

A marketplace of items being sold by individual sellers that each create their own listing titles and descriptions lacks a unified item identification system. The titles and descriptions are used to generate item clusters of related items. For example, items may be grouped based on a similarity or overlap between their titles, a difference in price being within a certain range, an attribute of the items being the same, or any suitable combination thereof. The criteria for grouping items may be automatically defined, defined by a user, or any suitable combination thereof.

A status of the inventory of items for sale on the marketplace (e.g., available quantities, average prices, price range, or any suitable combination thereof) is compared to a status of an inventory of items at an external retailer. The comparison may be performed by applying the same criteria used to generate the set of items on the marketplace to the items of the external retailer. For example, if a set of items in the marketplace is generated based on each of the items in the set having a particular string in the title, a quality of the items as being “new,” and a price in the range of $1,000-$5,000, that set of items can be compared to a set of new items at an external retailer in the same price range and having titles that match the particular string.

The comparison between the items for sale in the marketplace and the items for sale at the external retailer is used to generate one or more recommended actions for the marketplace. For example, if the marketplace has a comparable quantity of available items in a product cluster with better prices, a recommendation to promote the items based on price may be generated. As another example, if the marketplace has a better variety of items available in the product cluster, a recommendation to promote the items that are unavailable at the external retailer may be generated. As a third example, if the marketplace has fewer items available in the product cluster, a recommendation to procure additional inventory may be generated. As yet another example, if the marketplace has items available in the product cluster at a higher price than the external retailer, a recommendation to reduce prices may be generated.

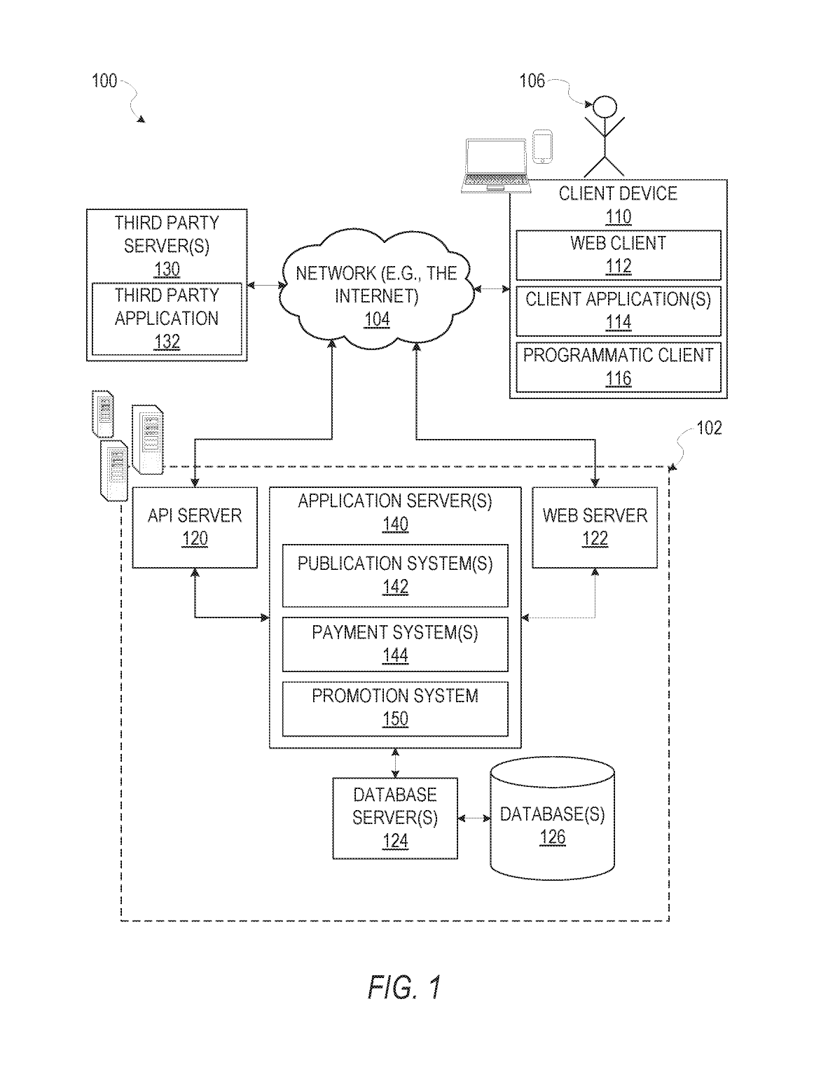

With reference to FIG. 1, an example embodiment of a high-level client-server-based network architecture 100 is shown. A networked system 102, in the example form of a network-based marketplace system, provides server-side functionality via a network 104 (e.g., the Internet or wide area network (WAN)) to one or more client devices 110. FIG. 1 illustrates, for example, a web client 112 (e.g., a browser, such as the Internet Explorer® browser developed by Microsoft® Corporation of Redmond, Wash.), a client application 114, and a programmatic client 116 executing on the client device 110.

The client device 110 may comprise, but is not limited to, a mobile phone, desktop computer, laptop, portable digital assistant (PDA), smart phone, tablet, ultra book, netbook, multi-processor system, microprocessor-based or programmable consumer electronics, or any other communication device that a user may utilize to access the networked system 102. In some embodiments, the client device 110 may comprise a display module (not shown) to display information (e.g., in the form of user interfaces). The client device 110 may be a device of a user that is used to perform a transaction involving digital items within the networked system 102. In one embodiment, the networked system 102 is a network-based marketplace that responds to requests for product listings, publishes publications comprising item listings of products available on the network-based marketplace, and manages payments for these marketplace transactions. One or more portions of the network 104 may be an ad hoc network, an intranet, an extranet, a virtual private network (VPN), a local area network (LAN), a wireless LAN (WLAN), a wide area network (WAN), a wireless WAN (WWAN), a metropolitan area network (MAN), a portion of the Internet, a portion of the public switched telephone network (PSTN), a cellular telephone network, a wireless network, a WiFi network, a WiMax network, another type of network, or a combination of two or more such networks.

Each client device 110 may include one or more applications (also referred to as “apps”) such as, but not limited to, a web browser, a messaging application, an electronic mail (email) application, an e-commerce site application (also referred to as a marketplace application), and the like. In some embodiments, if the e-commerce site application is included in a given client device 110, then this application is configured to locally provide the user interface and at least some of the functionalities with the application configured to communicate with the networked system 102, on an as needed basis, for data or processing capabilities not locally available (e.g., access to a database of items available for sale, to authenticate a user, to verify a method of payment). Conversely if the e-commerce site application is riot included in the client device 110, the client device 110 may use its web browser to access the e-commerce site (or a variant thereof) hosted on the networked system 102.

One or more users 106 may be a person, a machine, or other means of interacting with the client device 110. In example embodiments, the user 106 is not part of the network architecture 100, but may interact with the network architecture 100 via the client device 110 or other means. For instance, the user provides input (e.g., touch screen input or alphanumeric input) to the client device 110 and the input is communicated to the networked system 102 via the network 104. In this instance, the networked system 102, in response to receiving the input from the user, communicates information to the client device 110 via the network 104 to be presented to the user. In this way, the user can interact with the networked system 102 using the client device 110.

An application program interface (API) server 120 and a web server 122 are coupled to, and provide programmatic and web interfaces respectively to, one or more application servers 140. The application servers 140 host one or more publication systems 142 and payment systems 144, each of which comprises one or more modules or applications and each of which may be embodied as hardware, software, firmware, or any combination thereof. The application servers 140 are, in turn, shown to be coupled to one or more database servers 124 that facilitate access to one or more information storage repositories or database(s) 126. In an example embodiment, the databases 126 are storage devices that store information to be posted (e.g., publications or listings) to the publication system 142. The databases 126 may also store digital item information in accordance with example embodiments.

Additionally, a third party application 132, executing on third party server(s) 130, is shown as having programmatic access to the networked system 102 via the programmatic interface provided by the API server 120. For example, the third party application 132, utilizing information retrieved from the networked system 102, supports one or more features or functions on a website hosted by the third party. The third party website, for example, provides one or more promotional, marketplace, or payment functions that are supported by the relevant applications of the networked system 102.

The publication systems 142 provide a number of publication functions and services to the users 106 that access the networked system 102. The payment systems 144 likewise provide a number of functions to perform or facilitate payments and transactions. While the publication system 142 and payment system 144 are shown in FIG. 1 to both form part of the networked system 102, it will be appreciated that, in alternative embodiments, each system 142 and 144 may form part of a payment service that is separate and distinct from the networked system 102. In some embodiments, the payment systems 144 form part of the publication system 142.

The promotion system 150 provides functionality operable to perform various promotions using the supply and demand comparisons. For example, the promotion system 150 may access supply and demand data from the databases 126, the third party servers 130, the publication system 142, and other sources. In some example embodiments, the promotion system 150 analyzes listing data to identify listings to be promoted, sellers to be contacted regarding the increase of inventory or reduction of prices, or both. In some example embodiments, the promotion system 150 communicates with the publication systems 142 (e.g., accessing item listings) and payment system 144. In alternative embodiments, the promotion system 150 is a part of the publication system 142.

Further, while the client-server-based network architecture 100 shown in FIG. 1 employs a client-server architecture, the present inventive subject matter is, of course, not limited to such an architecture, and could equally well find application in a distributed, or peer-to-peer, architecture system, for example. The publication system 142, payment system 144, and promotion system 150 could also be implemented as standalone software programs, which do not necessarily have networking capabilities.

The web client 112 may access the various publication, payment, and promotion systems 142, 144 and 150 via the web interface supported by the web server 122. Similarly, the programmatic client 116 accesses the various services and functions provided by the publication and payment systems 142 and 144 via the programmatic interface provided by the API server 120. The programmatic client 116 may, for example, be a seller application (e.g., the Turbo Lister application developed by eBay® Inc., of San Jose, Calif.) to enable sellers to author and manage listings on the networked system 102 in an off-line manner, and to perform batch-mode communications between the programmatic client 116 and the networked system 102.

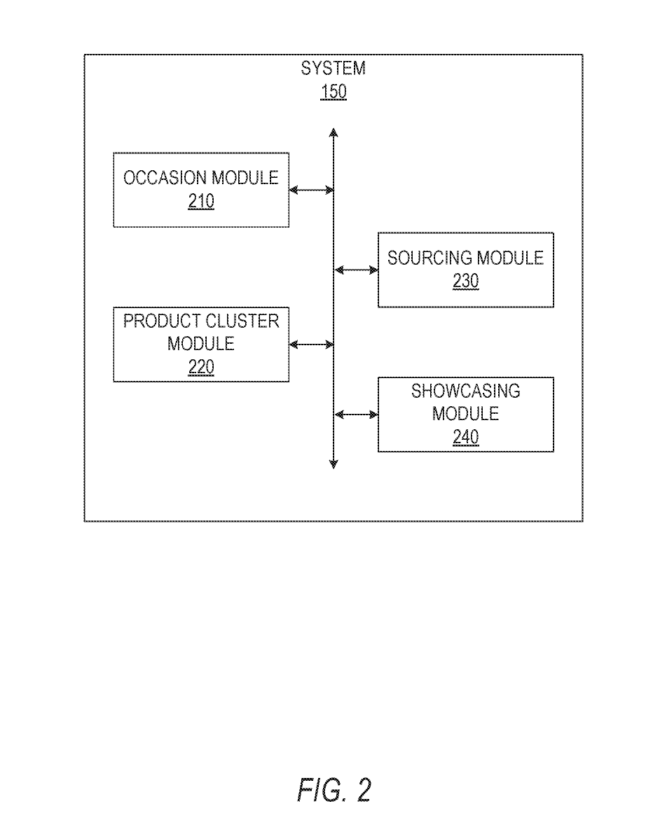

FIG. 2 is a block diagram illustrating modules of the promotion system 150 suitable for implementing an enhanced supply and demand tool, according to some example embodiments. As shown in FIG. 2, the promotion system 150 includes an occasion module 210, a product cluster module 220, a sourcing module 230, and a showcasing module 240.

The occasion module 210 determines a shopping occasion for a user. For example, shopping occasions may be divided into self-expressionist and treasure-hunting occasions. A self-expressionist shopping occasion is one in which a user is looking for interesting items, with an emphasis on the new and unique. A treasure-hunting shopping occasion is one in which a user is looking for items that are competitively priced, with an emphasis on finding a good deal. The occasion module 210 determines the shopping occasion based on behaviors of the user. For example, the items viewed by the user, search terms used by the user, particular sequence of recommended items selected by the user, or any suitable combination thereof may be used to determine the shopping occasion for the user. In some example embodiments, the actions of the current user are correlated with the actions of previous users associated with self-expressionist or treasure-hunting shopping occasions. For example, an administrator may categorize particular purchases as having been the culmination of a self-expressionist or treasure-hunting shopping occasion. The system can then analyze the behavior of the buyer prior the purchase to determine patterns that correlate with either self-expressionist or treasure-hunting shopping occasions. The resulting patterns can be applied to future shoppers to categorize their shopping occasion prior to the making of a purchase.

The product cluster module 220 clusters item listings into product clusters. For example, listed items may be clustered based on text strings in titles or descriptions of the listings, images in the listings, catalog data selected by the seller to be used for the listing, current, starting, or buy-it-now price for the listing, attributes of the listing (e.g., new/used, location, auction duration), or any suitable combination thereof.

The sourcing module 230 generates recommendations related to the generation of additional listings or modification of existing listings. For example, the sourcing module 230 may determine that an external retailer has more items available in a product cluster than are available on the marketplace served by the promotion system 150. In accordance with that determination, the sourcing module 230 may generate a recommendation to solicit additional items for the product cluster. As another example, the sourcing module 230 may determine that an external retailer has better prices for items in a product cluster than the marketplace served by the promotion system 150. In accordance with that determination, the sourcing module 230 may generate a recommendation to ask sellers to reduce prices for items in the product cluster.

The showcasing module 240 generates recommendations related to the promotion of listings. For example, the showcasing module 240 may determine that different items in a product cluster including items viewed by the user are available on the marketplace and not available from an external retailer. In accordance with that determination, the showcasing module 240 may generate a recommendation to promote unique items to users on a self-expressionist shopping occasion. As another example, the showcasing module 240 may determine that items in a product cluster including items viewed by the user are lower-priced than comparable items available from an external retailer. In accordance with that determination, the showcasing module 240 may generate a recommendation to promote items to users on a treasure-hunting shopping occasion.

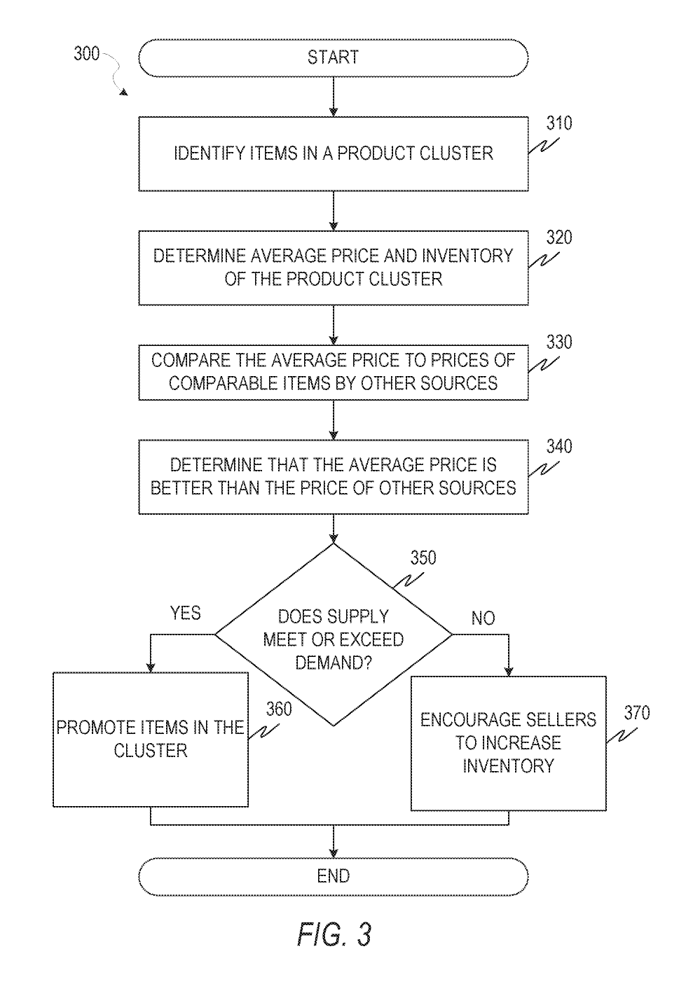

FIG. 3 is a flow diagram illustrating operations of a computer system performing a method 300 suitable for implementing an enhanced supply and demand tool, according to some example embodiments. By way of example and not limitation, the operations of the method 300 are described as being performed by the modules of FIG. 2.

In operation 310, the product cluster module 220 identifies items in a product cluster. For example, listed items may be clustered based on text strings in the titles or descriptions of the listings, images in the listings, catalog data selected by the seller to be used for the listing, current, starting, or buy-it-now price for the listing, attributes of the listing (e.g., new/used, location, auction duration), or any suitable combination thereof. The term “characteristics” may be used to encompass any single one or combination of these clustering criteria. The average price and number of items available in the product cluster are determined by the product cluster module 220 in operation 320. The sourcing module 230, the showcasing module 240, or both compare the average price of the product cluster to prices of comparable items available from other sources in operation 330. In operation 340, the sourcing module 230, the showcasing module 240, or both determine that the average price of items in the cluster is better (lower) than the average price of items available from other sources.

In operation 350, a determination is made as to whether the quantity of items available in the product cluster meets or exceeds the current or predicted demand. For example, the number of items sold in the product cluster in a preceding period may be used to predict the number of items needed in the current period. The preceding period may be an immediately preceding period (e.g., the previous month, week, quarter, or year) or a seasonally preceding period (e.g., the corresponding month, week, or quarter of the previous year). As another example, demand may be measured based on extraction of data from external web sites showing quantities of items sold, either broken down by item or in aggregate categories. The ability of supply to meet demand may also be determined based on the conversion rate of item searches for items in the product cluster, For example, if the historic average conversion rate of searches in the product cluster is 50%, but the current conversion rate is 25%, an inference that inventory is not currently sufficient to meet demand may be made. Another method of determining if supply meets demand is to consider the number of unique bidders on items for sale by auction in the product cluster. For example, if the historic average number of bidders is 3, but the current average number of bidders is 5, an inference that inventory is not currently sufficient to meet demand may be made.

If the inventory is sufficient to meet demand, then items in the cluster are promoted by the showcasing module 240 in operation 360. If the inventory is insufficient to meet demand, a message is generated to sellers that have previously listed items in the product cluster to encourage them to list additional items to meet demand (operation 370).

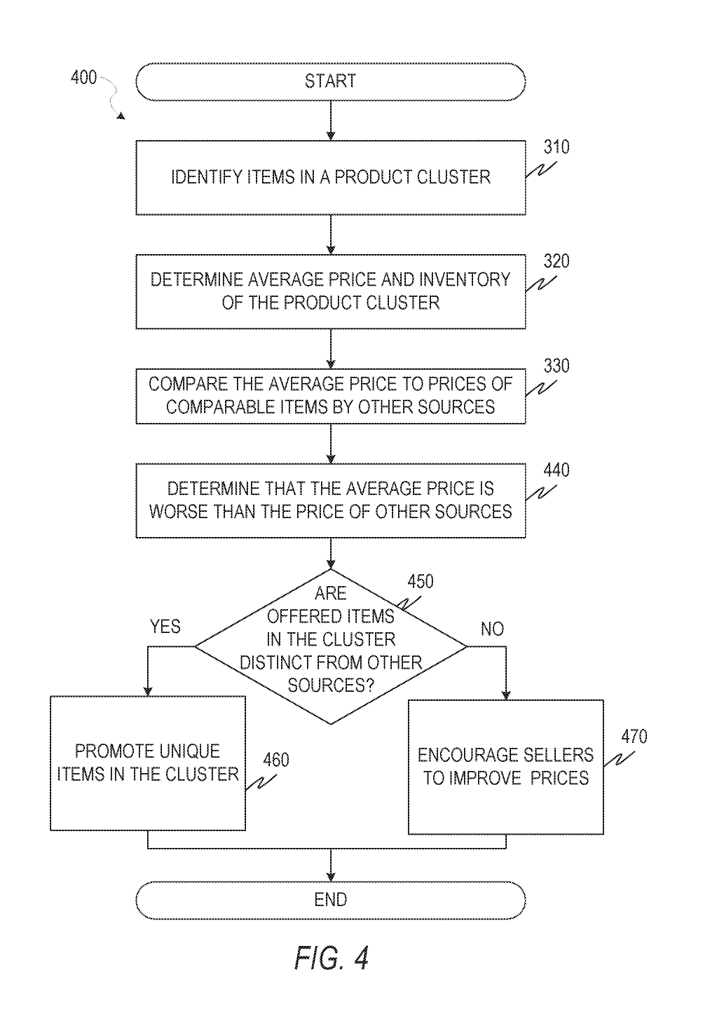

FIG. 4 is a flow diagram illustrating operations of a computer system performing a method 400 suitable for implementing an enhanced supply and demand tool, according to some example embodiments. By way of example and not limitation, the operations of the method 400 are described as being performed by the modules of FIG. 2. Operations 310-330 of the method 400 are described above with respect to FIG. 3. In operation 440, the sourcing module 230, the showcasing module 240, or both determine that the average price of items in the cluster is worse (higher) than the average price of items available from other sources.

In operation 450, a determination is made as to whether the items available in the product cluster are distinct from the items available from other sources. If the items are distinct, then items in the cluster that are not available from other sources are promoted by the showcasing module 240 in operation 460. If the items are not distinct, a message is generated to sellers that have listed items in the product cluster to encourage them to reduce their prices in order to be more competitive (operation 470).

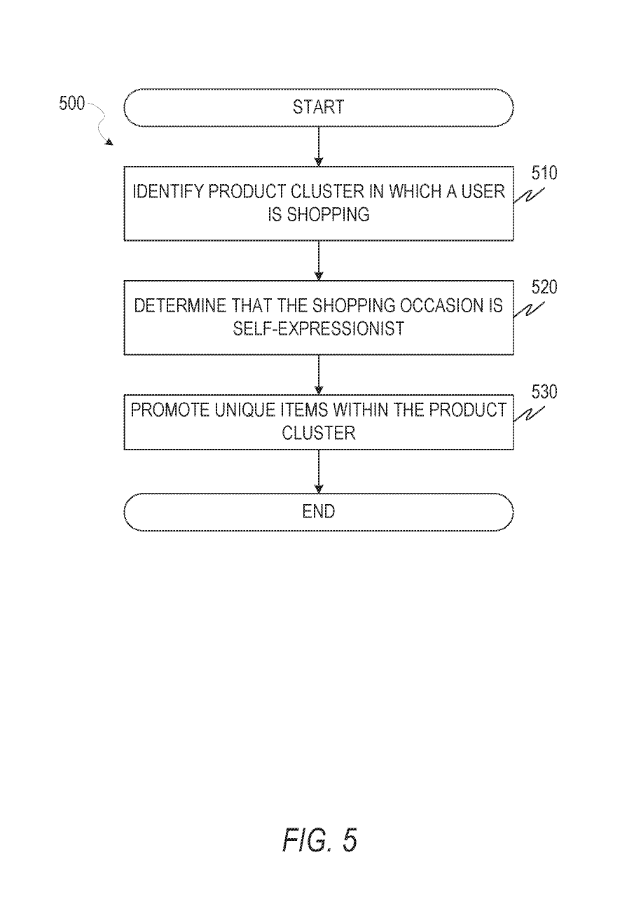

FIG. 5 is a flow diagram illustrating operations of a computer system performing a method 500 suitable for implementing an enhanced supply and demand tool, according to some example embodiments. By way of example and not limitation, the operations of the method 500 are described as being performed by the modules of FIG. 2.

In operation 510, the product cluster module 220 identifies a product cluster in which a user is shopping. For example, if the user looks at a series of item listings, each of which includes “marvel” in the title, a product cluster for items also having that word in the title may be identified.

In operation 520, the shopping occasion module 210 determines that the shopping occasion for the user is self-expressionist. For example, the series of items browsed by the user may have a high degree of variety, indicating that the user is not looking for a good price on a particular item, but instead is looking for items that spark interest. The degree of variety may be determined by using an n-dimensional vector for each item and determining the average distance between the items in the n-dimensional space. Elements of the n-dimensional vector may include a location in a category hierarchy, attributes, and the presence or absence of words in descriptions or titles. The threshold for a high degree of variety may be predetermined for the system or customized for the user.

In operation 530, based on the identified product cluster and the determination that the shopping occasion is self-expressionist, the showcasing module 240 promotes items within the product cluster that are available on the marketplace but unavailable from other sources. For example, web sites offering items for sale from the other sources can be scraped to determine which items the other sources are offering at what prices. Accordingly, items for sale on the marketplace that are unavailable at the other sources can be determined by comparing the inventory of the marketplace with the scraped data and identifying items that are only available on the marketplace.

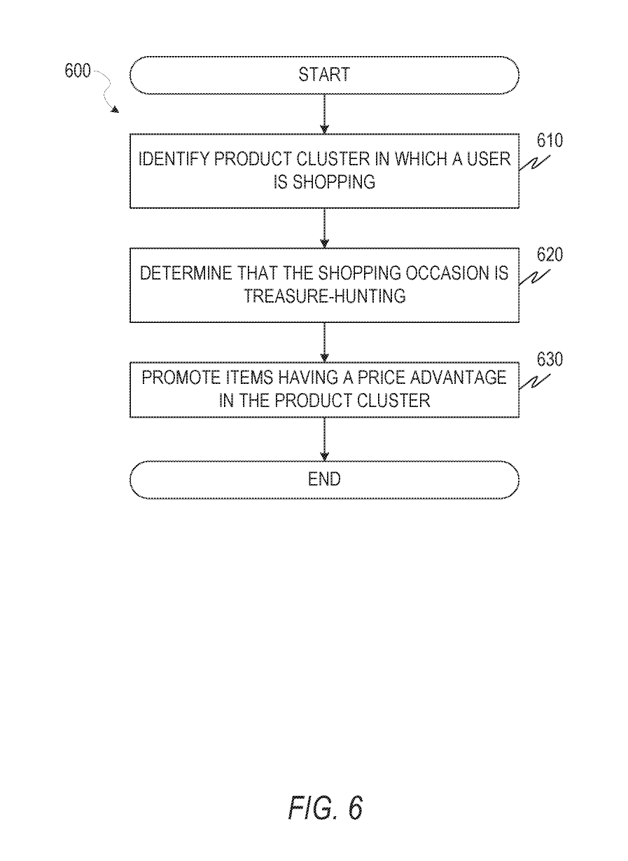

FIG. 6 is a flow diagram illustrating operations of a computer system performing a method 600 suitable for implementing an enhanced supply and demand tool, according to some example embodiments. By way of example and not limitation, the operations of the method 600 are described as being performed by the modules of FIG. 2.

In operation 610, the product cluster module 220 identifies a product cluster in which a user is shopping. In operation 620, the shopping occasion module 210 determines that the shopping occasion for the user is treasure-hunting. For example, the series of items browsed by the user may have a high degree of similarity a low degree of variety, indicating that the user already knows what the desired item is and is looking for a good price on that item.

In operation 630, based on the identified product cluster and the determination that the shopping occasion is treasure-hunting, the showcasing module 240 promotes items within the product cluster that are available on the marketplace at a better price than from other sources.

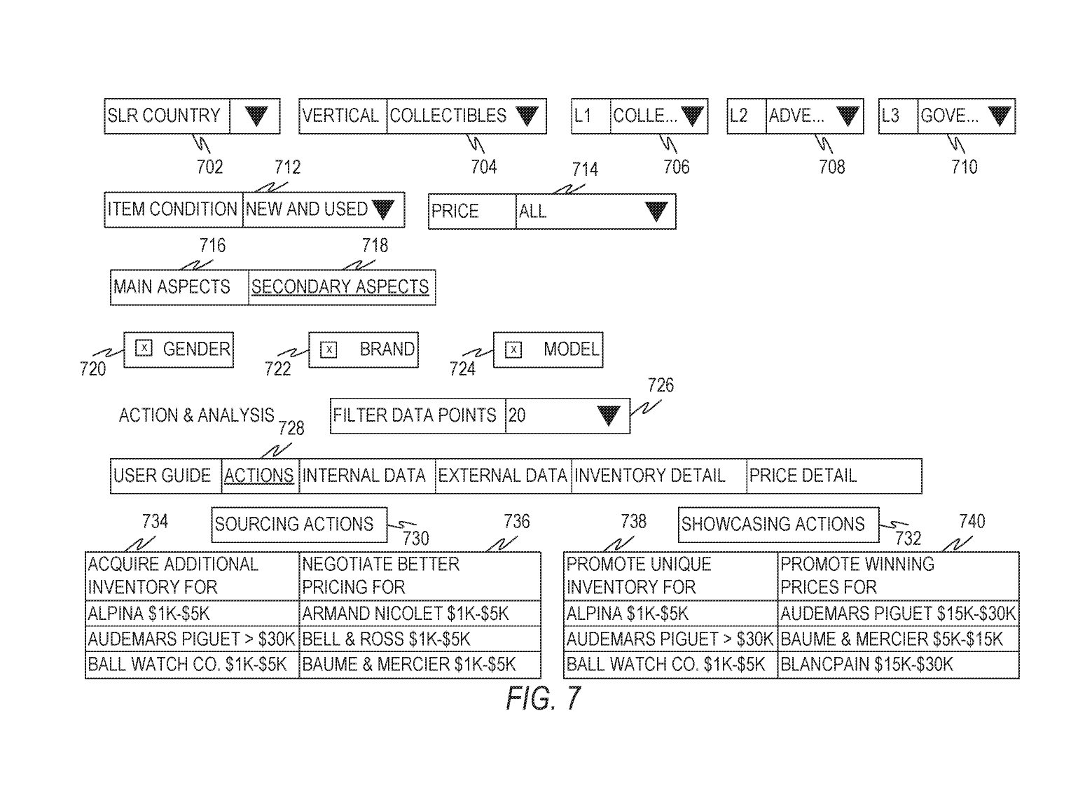

FIG. 7 is an interface diagram illustrating a user interface for an enhanced supply and demand tool, according to some example embodiments.

The selectors 702, 704, 706, 708, 710, and 712 are operable to define parameters on which product clusters should be viewed. The selector 702 allows selection of the seller country. For example, the United States may be selected. The selectors 704, 706, 708, and 710 operate together to allow the selection of a particular grouping in a product hierarchy, as selected by the seller. For example, the fashion vertical may be selected, and narrowed to jewelry, watches, and wristwatches. Options 714 and 716 allow the user to switch between main aspects and secondary aspects of the product cluster. As shown in FIG. 7, the option 714 is activated. Text area 718 reports a percentage of the aspects of the product cluster that are covered by the selected item condition using the selectors 712, 726, and 728. Options 720, 722, and 724 allow the selection to filter items by gender, brand, and model, respectively. As shown, option 720 is deactivated and options 722 and 724 are activated. Selector 726 is operable to select the number of results to be displayed. Selector 728 is operable to select the price range of items for which results are to be reported. Identified opportunities matching the selected criteria are ranked based on their revenue potentials, and the top opportunities of each type are shown, up to the number selected using the selector 726.

Menu bar 730 is operable to select one of a number of data views. A user guide shows information on using the user interface. An actions view, currently selected in FIG. 7, will be described in further detail below. An internal data view shows information regarding listings available in the marketplace. An external data view shows information regarding items available from other sources. An inventory detail and price detail view show comparisons between marketplace and external listings, aggregated by inventory and price, respectively. In some example embodiments, the inventory detail shows a percentage overlap of items in the product cluster between the marketplace and the external source, a percentage of items that are unique to the marketplace, and a percentage of items that are available from the external source but not in the marketplace. Similarly, in some example embodiments, a price detail view shows a percentage of items in the product cluster having the same prices in the marketplace and the external source, a percentage having better prices in the marketplace, and a percentage having better prices in the external source.

With respect to the actions view, the possible actions are divided broadly into sourcing actions 730 and showcasing actions 732. The sourcing actions 730 include product clusters for which a recommendation of acquiring additional inventory is generated (column 734) and product clusters for which a recommendation of negotiating better pricing is generated (column 736). The showcasing actions 732 include product clusters for which a recommendation of promoting unique inventory is generated (column 738) and product clusters for which a recommendation of promoting items based on pricing is generated (column 740). Each of the entries in the recommendation columns may act as a button or hypertext link and be operable to cause the corresponding recommendation to be followed for the product cluster of the entry. A detailed recommendation view for the product cluster may include a projected value of following the recommendation. For example, if the current inventory does not meet demand, a reduced value of sales can be calculated, which would also be a projected value of increasing the supply. As another example, a value of promoting items may be calculated based on a projected success rate of the promotion, a number of shoppers that will be promoted to, and an average price of the goods promoted.

A recommendation to reduce price may include a projected sales volume increase corresponding to the reduced price. For example, when prices on the marketplace are in-line with external prices, the sales rate may be 30% higher than when prices on the marketplace are 10% higher than external sources. Accordingly, if a determination is made that current prices for the product cluster are 10% higher than external sources, the recommendation to reduce the prices may indicate that a 10% reduction is prices is expected to result in a 30% increase in sales.

### Modules, Components, and Logic

Certain embodiments are described herein as including logic or a number of components, modules, or mechanisms. Modules may constitute hardware modules. A “hardware module” is a tangible unit capable of performing certain operations and may be configured or arranged in a certain physical manner. In various example embodiments, one or more computer systems (e.g., a standalone computer system, a client computer system, or a server computer system) or one or more hardware modules of a computer system (e.g., a processor or a group of processors) may be configured by software (e.g., an application or application portion) as a hardware module that operates to perform certain operations as described herein.

In some embodiments, a hardware module may be implemented mechanically, electronically, or any suitable combination thereof. For example, a hardware module may include dedicated circuitry or logic that is permanently configured to perform certain operations. For example, a hardware module may be a special-purpose processor, such as a field-programmable gate array (FPGA) or an application specific integrated circuit (ASIC). A hardware module may also include programmable logic or circuitry that is temporarily configured by software to perform certain operations. For example, a hardware module may include software executed by a general-purpose processor or other programmable processor. Once configured by such software, hardware modules become specific machines (or specific components of a machine) uniquely tailored to perform the configured functions and are no longer general-purpose processors. It will be appreciated that the decision to implement a hardware module mechanically, in dedicated and permanently configured circuitry, or in temporarily configured circuitry (e.g., configured by software) may be driven by cost and time considerations.

Accordingly, the phrase “hardware module” should be understood to encompass a tangible entity, be that an entity that is physically constructed, permanently configured (e.g., hardwired), or temporarily configured (e.g., programmed) to operate in a certain manner or to perform certain operations described herein. As used herein, “hardware-implemented module” refers to a hardware module. Considering embodiments in which hardware modules are temporarily configured (e.g., programmed), each of the hardware modules need not be configured or instantiated at any one instance in time. For example, where a hardware module comprises a general-purpose processor configured by software to become a special-purpose processor, the general-purpose processor may be configured as respectively different special-purpose processors (e.g., comprising different hardware modules) at different times. Software accordingly configures a particular processor or processors, for example, to constitute a particular hardware module at one instance of time and to constitute a different hardware module at a different instance of time.

Hardware modules can provide information to, and receive information from, other hardware modules. Accordingly, the described hardware modules may be regarded as being communicatively coupled. Where multiple hardware modules exist contemporaneously, communications may be achieved through signal transmission e.g., over appropriate circuits and buses) between or among two or more of the hardware modules. In embodiments in which multiple hardware modules are configured or instantiated at different times, communications between such hardware modules may be achieved, for example, through the storage and retrieval of information in memory structures to which the multiple hardware modules have access. For example, one hardware module may perform an operation and store the output of that operation in a memory device to which it is communicatively coupled. A further hardware module may then, at a later time, access the memory device to retrieve and process the stored output. Hardware modules may also initiate communications with input or output devices, and can operate on a resource (e.g., a collection of information).

The various operations of example methods described herein may be performed, at least partially, by one or more processors that are temporarily configured (e.g., by software) or permanently configured to perform the relevant operations. Whether temporarily or permanently configured, such processors may constitute processor-implemented modules that operate to perform one or more operations or functions described herein. As used herein, “processor-implemented module” refers to a hardware module implemented using one or more processors.

Similarly, the methods described herein may be at least partially processor-implemented, with a particular processor or processors being an example of hardware. For example, at least some of the operations of a method may be performed by one or more processors or processor-implemented modules. Moreover, the one or more processors may also operate to support performance of the relevant operations in a “cloud computing” environment or as a “software as a service” (SaaS). For example, at least some of the operations may be performed by a group of computers (as examples of machines including processors), with these operations being accessible via a network (e.g., the Internet) and via one or more appropriate interfaces (e.g., an application program interface (API)).

The performance of certain of the operations may be distributed among the processors, not only residing within a single machine, but deployed across a number of machines. In some example embodiments, the processors or processor-implemented modules may be located in a single geographic location (e.g., within a home environment, an office environment, or a server farm), in other example embodiments, the processors or processor-implemented modules may be distributed across a number of geographic locations.

### Machine and Software Architecture

The modules, methods, applications and so forth described in conjunction with FIGS. 1-7 are implemented in some embodiments in the context of a machine and an associated software architecture. The sections below describe representative software architecture(s) and machine (e.g., hardware) architecture(s) that are suitable for use with the disclosed embodiments.

Software architectures are used in conjunction with hardware architectures to create devices and machines tailored to particular purposes. For example, a particular hardware architecture coupled with a particular software architecture will create a mobile device, such as a mobile phone, tablet device, or so forth. A slightly different hardware and software architecture may yield a smart device for use in the “internet of things.” While yet another combination produces a server computer for use within a cloud computing architecture. Not all combinations of such software and hardware architectures are presented here as those of skill in the art can readily understand how to implement the invention in different contexts from the disclosure contained herein.

### Software Architecture

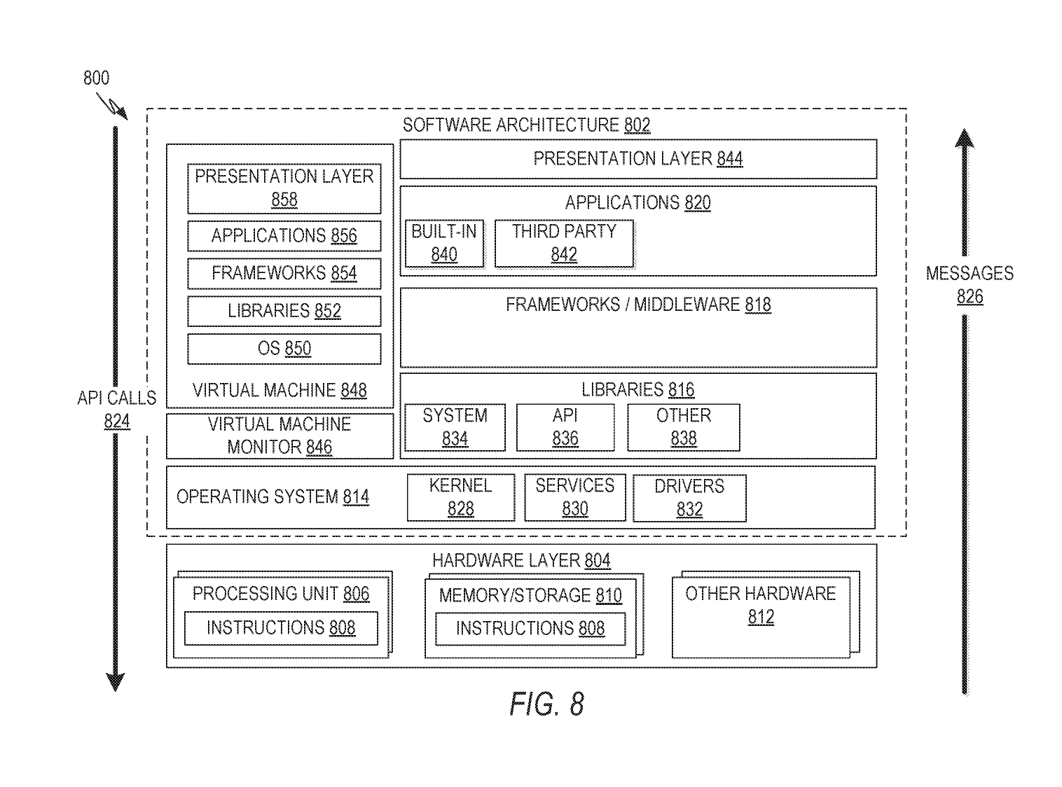

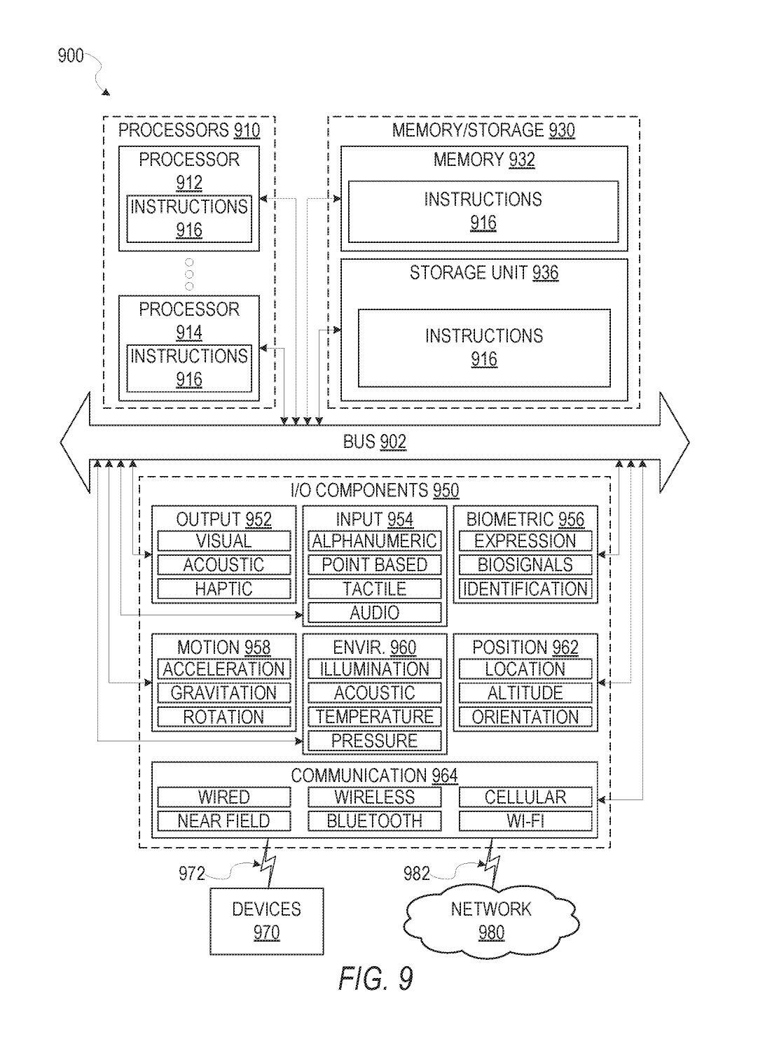

FIG. 8 is a block diagram 800 illustrating a representative software architecture 802, which may be used in conjunction with various hardware architectures herein described. FIG. 8 is merely a non-limiting example of a software architecture and it will be appreciated that many other architectures may be implemented to facilitate the functionality described herein. The software architecture 802 may be executing on hardware such as machine 900 of FIG. 9 that includes, among other things, processors 910, memory 930, and I/O components 950. A representative hardware layer 804 is illustrated and can represent, for example, the machine 900 of FIG. 9. The representative hardware layer 804 comprises one or more processing units 806 having associated executable instructions 808. Executable instructions 808 represent the executable instructions of the software architecture 802, including implementation of the methods, modules and so forth of FIGS. 1-7. Hardware layer 804 also includes memory or storage modules 810, which also have executable instructions 808. Hardware layer 804 may also comprise other hardware as indicated by 812 which represents any other hardware of the hardware layer 804, such as the other hardware illustrated as part of machine 900.

In the example architecture of FIG. 8, the software 802 may be conceptualized as a stack of layers where each layer provides particular functionality. For example, the software 802 may include layers such as an operating system 814, libraries 816, frameworks/middleware 818, applications 820 and presentation layer 844. Operationally, the applications 820 or other components within the layers may invoke application programming interface (API) calls 824 through the software stack and receive a response, returned values, and so forth illustrated as messages 826 in response to the API calls 824. The layers illustrated are representative in nature and not all software architectures have all layers. For example, sonic mobile or special purpose operating systems may not provide a frameworks/middleware layer 818, while others may provide such a layer. Other software architectures may include additional or different layers.

The operating system 814 may manage hardware resources and provide common services. The operating system 814 may include, for example, a kernel 828, services 830, and drivers 832. The kernel 828 may act as an abstraction layer between the hardware and the other software layers. For example, the kernel 828 may be responsible for memory management, processor management (e.g., scheduling), component management, networking, security settings, and so on. The services 830 may provide other common services for the other software layers. The drivers 832 may be responsible for controlling or interfacing with the underlying hardware. For instance, the drivers 832 may include display drivers, camera drivers, Bluetooth® drivers, flash memory drivers, serial communication drivers (e.g., Universal Serial Bus (USB) drivers), Wi-Fi® drivers, audio drivers, power management drivers, and so forth, depending on the hardware configuration.

The libraries 816 may provide a common infrastructure that may be utilized by the applications 820 or other components or layers. The libraries 816 typically provide functionality that allows other software modules to perform tasks in an easier fashion than to interface directly with the underlying operating system 814 functionality (e.g., kernel 828, services 830 or drivers 832). The libraries 816 may include system 834 libraries (e.g., C standard library) that may provide functions such as memory allocation functions, string manipulation functions, mathematic functions, and the like. In addition, the libraries 816 may include API libraries 836 such as media libraries (e.g., libraries to support presentation and manipulation of various media format such as MPEG4, H.264, MP3, AAC, AMR, JPG, PNG), graphics libraries (e.g., an OpenGL framework that may be used to render 2D and 3D in graphic content on a display), database libraries (e.g., SQLite that may provide various relational database functions), web libraries (e.g., WebKit that may provide web browsing functionality), and the like. The libraries 816 may also include a wide variety of other libraries 838 to provide many other APIs to the applications 820 and other software components/modules.

The frameworks 818 (also sometimes referred to as middleware) may provide a higher-level common infrastructure that may be utilized by the applications 820 or other software components/modules. For example, the frameworks 818 may provide various graphic user interface (GUI) functions, high-level resource management, high-level location services, and so forth. The frameworks 818 may provide a broad spectrum of other APIs that may be utilized by the applications 820 or other software components/modules, some of which may be specific to a particular operating system or platform.

The applications 820 include built-in applications 840 or third party applications 842. Examples of representative built-in applications 840 include, but are not limited to, a contacts application, a browser application, a book reader application, a location application, a media application, a messaging application, or a game application. Third party applications 842 may include any of the built in applications as well as a broad assortment of other applications. In a specific example, the third party application 842 (e.g., an application developed using the Android™ or iOS™ software development kit (SDK) by an entity other than the vendor of the particular platform) is mobile software running on a mobile operating system such as iOS™, Android™, Windows® Phone, or other mobile operating systems. In this example, the third party application 842 invokes the API calls 824 provided by the mobile operating system such as operating system 814 to facilitate functionality described herein. The occasion module 210, product cluster module 220, sourcing module 230, and showcasing module 240 of the promotion system 150 may be implemented as one or more third party applications 842.

The applications 820 may utilize built in operating system functions (e.g., kernel 828, services 830 and/or drivers 832), libraries (e.g., system 834, APIs 836, and other libraries 838), and frameworks/middleware 818 to create user interfaces to interact with users of the system. Alternatively, or additionally, in some systems interactions with a user may occur through a presentation layer, such as presentation layer 844. In these systems, the application/module “logic” can be separated from the aspects of the application/module that interact with a user.

Some software architectures utilize virtual machines. In the example of FIG. 8, this is illustrated by virtual machine 848. A virtual machine creates a software environment where applications/modules can execute as if they were executing on a hardware machine (e.g., such as the machine of FIG. 9). A virtual machine is hosted by a host operating system (e.g., operating system 814 in FIG. 9) and typically, although not always, has a virtual machine monitor 846, which manages the operation of the virtual machine 848 as well as the interface with the host operating system (e.g., operating system 814). A software architecture executes within the virtual machine 848 such as an operating system 850, libraries 852, frameworks/middleware 854, applications 856 or presentation layer 858. These layers of software architecture executing within the virtual machine 848 can be the same as corresponding layers previously described or may be different.

### Example Machine Architecture and Machine-Readable Medium

FIG. 9 is a block diagram illustrating components of a machine 900, according to some example embodiments, able to read instructions from a machine-readable medium (e.g., a machine-readable storage medium) and perform any one or more of the methodologies discussed herein. Specifically, FIG. 9 shows a diagrammatic representation of the machine 900 in the example form of a computer system, within which instructions 916 (e.g., software, a program, an application, an applet, an app, or other executable code) for causing the machine 900 to perform any one or more of the methodologies discussed herein may be executed. For example the instructions may cause the machine to execute the flow diagrams of FIGS. 1-7. Additionally, or alternatively, the instructions may implement the occasion module 210, the product cluster module 220, the sourcing module 230, and the showcasing module 240 of FIG. 2. The instructions transform the general, non-programmed machine into a particular machine programmed to carry out the described and illustrated functions in the manner described. In alternative embodiments, the machine 900 operates as a standalone device or may be coupled (e.g., networked) to other machines. In a networked deployment, the machine 900 may operate in the capacity of a server machine or a client machine in a server-client network environment, or as a peer machine in a peer-to-peer (or distributed) network environment. The machine 900 may comprise, but is not limited to, a server computer, a client computer, a personal computer (PC), or any machine capable of executing the instructions 916, sequentially or otherwise, that specify actions to be taken by machine 900. Further, while only a single machine 900 is illustrated, the term “machine” shall also be taken to include a collection of machines 900 that individually or jointly execute the instructions 916 to perform any one or more of the methodologies discussed herein.

The machine 900 may include processors 910, memory 930, and I/O components 950, which may be configured to communicate with each other such as via a bus 902. In an example embodiment, the processors 910 (e.g., a central processing unit (CPU), a reduced instruction set computing (RISC) processor, a complex instruction set computing (CISC) processor, a graphics processing unit (GPU), a digital signal processor (DSP), an application specific integrated circuit (ASIC), a radio-frequency integrated circuit (RFIC), another processor, or any suitable combination thereof) may include, for example, processor 912 and processor 914 that may execute instructions 916. The term “processor” is intended to include multi-core processors 910 that comprise two or more independent processors 912, 914 (sometimes referred to as “cores”) that may execute instructions 916 contemporaneously. Although FIG. 9 shows multiple processors, the machine 900 may include a single processor with a single core, a single processor with multiple cores, multiple processors with a single core, multiple processors with multiples cores, or any combination thereof.

The memory/storage 930 may include a memory 932, such as a main memory, or other memory storage, and a storage unit 936, each accessible to the processors 910, such as via the bus 902. The storage unit 936 and memory 932 store the instructions 916 embodying any one or more of the methodologies or functions described herein. The instructions 916 may also reside, completely or partially, within the memory 932, within the storage unit 936, within at least one of the processors 910 (e.g., within the processor's cache memory), or any suitable combination thereof, during execution thereof by the machine 900. Accordingly, the memory 932, the storage unit 936, and the memory of processors 910 are examples of machine-readable media.

As used herein, “machine-readable medium” means a device able to store instructions and data temporarily or permanently and may include, but is not be limited to, random-access memory (RAM), read-only memory (ROM), buffer memory, flash memory, optical media, magnetic media, cache memory, other types of storage (e.g., electronically erasable programmable read-only memory (EEPROM)) or any suitable combination thereof. The term “machine-readable medium” should be taken to include a single medium or multiple media (e.g., a centralized or distributed database, or associated caches and servers) able to store instructions 916. The term “machine-readable medium” shall also be taken to include any medium, or combination of multiple media, that is capable of storing instructions (e.g., instructions 916) for execution by a machine (e.g., machine 900), such that the instructions, when executed by one or more processors of the machine 900 (e.g., processors 910), cause the machine 900 to perform any one or more of the methodologies described herein. Accordingly, a “machine-readable medium” refers to a single storage apparatus or device, as well as “cloud-based” storage systems or storage networks that include multiple storage apparatus or devices. The term “machine-readable medium” excludes signals per se.

The I/O components 950 may include a wide variety of components to receive input, provide output, produce output, transmit information, exchange information, capture measurements, and so on. The specific I/O components 950 that are included in a particular machine will depend on the type of machine. For example, portable machines such as mobile phones will likely include a touch input device or other such input mechanisms, while a headless server machine will likely not include such a touch input device. It will be appreciated that the I/O components 950 may include many other components that are not shown in FIG. 9. The I/O components 950 are grouped according to functionality merely for simplifying the following discussion and the grouping is in no way limiting. In various example embodiments, the I/O components 950 may include output components 952 and input components 954. The output components 952 may include visual components (e.g., a display such as a plasma display panel (PDP), light emitting diode (LED) display, a liquid crystal display (LCD), a projector, or a cathode ray tube (CRT)), acoustic components (e.g., speakers), haptic components (e.g., a vibratory motor, resistance mechanisms), other signal generators, and so forth. The input components 954 may include alphanumeric input components (e.g., a keyboard, a touch screen configured to receive alphanumeric input, a photo-optical keyboard, or other alphanumeric input components), point based input components (e.g., a mouse, a touchpad, a trackball, a joystick, a motion sensor, or other pointing instrument), tactile input components (e.g., a physical button, a touch screen that provides location or force of touches or touch gestures, or other tactile input components), audio input components (e.g., a microphone), and the like.

In further example embodiments, the I/O components 950 may include biometric components 956, motion components 958, environmental components 960, or position components 962 among a wide array of other components. For example, the biometric components 956 may include components to detect expressions (e.g., hand expressions, facial expressions, vocal expressions, body gestures, or eye tracking), measure biosignals (e.g., blood pressure, heart rate, body temperature, perspiration, or brain waves), identify a person (e.g., voice identification, retinal identification, facial identification, fingerprint identification, or electroencephalogram based identification), and the like. The motion components 958 may include acceleration sensor components (e.g., accelerometer), gravitation sensor components, rotation sensor components (e.g., gyroscope), and so forth. The environmental components 960 may include, for example, illumination sensor components (e.g., photometer), temperature sensor components (e.g., one or more thermometer that detect ambient temperature), humidity sensor components, pressure sensor components (e.g., barometer), acoustic sensor components (e.g., one or more microphones that detect background noise), proximity sensor components (e.g., infrared sensors that detect nearby objects), gas sensors (e.g., gas detection sensors to detection concentrations of hazardous gases for safety or to measure pollutants in the atmosphere), or other components that may provide indications, measurements, or signals corresponding to a surrounding physical environment. The position components 962 may include location sensor components (e.g., a Global Position System (GPS) receiver component), altitude sensor components (e.g., altimeters or barometers that detect air pressure from which altitude may be derived), orientation sensor components (e.g., magnetometers), and the like.

Communication may be implemented using a wide variety of technologies. The I/O components 950 may include communication components 964 operable to couple the machine 900 to a network 980 or devices 970 via coupling 982 and coupling 972, respectively. For example, the communication components 964 may include a network interface component or other suitable device to interface with the network 980. In further examples, communication components 964 may include wired communication components, wireless communication components, cellular communication components, near field communication (NEC) components, Bluetooth® components (e.g., Bluetooth® Low Energy), Wi-Fi® components, and other communication components to provide communication via other modalities. The devices 970 may be another machine or any of a wide variety of peripheral devices (e.g., a peripheral device coupled via a Universal Serial Bus (USB)).

Moreover, the communication components 964 may detect identifiers or include components operable to detect identifiers. For example, the communication components 964 may include radio frequency identification tag reader components, NFC smart tag detection components, optical reader components (e.g., an optical sensor to detect one-dimensional bar codes such as Universal Product Code (UPC) bar code, multi-dimensional bar codes such as Quick Response (QR) code, Aztec code, Data Matrix, Dataglyph, MaxiCode, PDF417, Ultra Code, UCC RSS-2D bar code, and other optical codes), or acoustic detection components (e.g., microphones to identify tagged audio signals). In addition, a variety of information may be derived via the communication components 964, such as, location via Internet Protocol (IP) geo-location, location via Wi-Fi® signal triangulation, location via detecting a NFC beacon signal that may indicate a particular location, and so forth.

### Transmission Medium

In various example embodiments, one or more portions of the network 980 may be an ad hoc network, an intranet, an extranet, a virtual private network (VPN), a local area network (LAN), a wireless LAN (WLAN), a wide area network (WAN), a wireless WAN (WWAN), a metropolitan area network (MAN), the Internet, a portion of the Internet, a portion of the public switched telephone network (PSTN), a plain old telephone service (POTS) network, a cellular telephone network, a wireless network, a Wi-Fi® network, another type of network, or a combination of two or more such networks. For example, the network 980 or a portion of the network 980 may include a wireless or cellular network and the coupling 982 may be a Code Division Multiple Access (CDMA) connection, a Global System for Mobile communications (GSM) connection, or other type of cellular or wireless coupling. In this example, the coupling 982 may implement any of a variety of types of data transfer technology, such as Single Carrier Radio Transmission Technology (1xRTT), Evolution-Data Optimized (EVDO) technology, General Packet Radio Service (GPRS) technology, Enhanced Data rates for GSM Evolution (EDGE) technology, third Generation Partnership Project (3GPP) including 3G, fourth generation wireless (4G) networks, Universal Mobile Telecommunications System (UMTS), High Speed Packet Access (HSPA), Worldwide Interoperability for Microwave Access (WiMAX), Long Term Evolution (LTE) standard, others defined by various standard setting organizations, other long range protocols, or other data transfer technology.

The instructions 916 may be transmitted or received over the network 980 using a transmission medium via a network interface device (e.g., a network interface component included in the communication components 964) and utilizing any one of a number of well-known transfer protocols (e.g., hypertext transfer protocol (HTTP)). Similarly, the instructions 916 may be transmitted or received using a transmission medium via the coupling 972 (e.g., a peer-to-peer coupling) to devices 970. The term “transmission medium” shall be taken to include any intangible medium that is capable of storing, encoding, or carrying instructions 916 for execution by the machine 900, and includes digital or analog communications signals or other intangible medium to facilitate communication of such software.

### Language

Throughout this specification, plural instances may implement components, operations, or structures described as a single instance. Although individual operations of one or more methods are illustrated and described as separate operations, one or more of the individual operations may be performed concurrently, and nothing requires that the operations be performed in the order illustrated. Structures and functionality presented as separate components in example configurations may be implemented as a combined structure or component. Similarly, structures and functionality presented as a single component may be implemented as separate components. These and other variations, modifications, additions, and improvements fall within the scope of the subject matter herein.

Although an overview of the inventive subject matter has been described with reference to specific example embodiments, various modifications and changes may be made to these embodiments without departing from the broader scope of embodiments of the present disclosure. Such embodiments of the inventive subject matter may be referred to herein, individually, or collectively, by the term “invention” merely for convenience and without intending to voluntarily limit the scope of this application to any single disclosure or inventive concept if more than one is, in fact, disclosed.

The embodiments illustrated herein are described in sufficient detail to enable those skilled in the art to practice the teachings disclosed. Other embodiments may be used and derived therefrom, such that structural and logical substitutions and changes may be made without departing from the scope of this disclosure. The Detailed Description, therefore, is not to be taken in a limiting sense, and the scope of various embodiments is defined only by the appended claims, along with the full range of equivalents to which such claims are entitled.

As used herein, the term “or” may be construed in either an inclusive or exclusive sense. Moreover, plural instances may be provided for resources, operations, or structures described herein as a single instance. Additionally, boundaries between various resources, operations, modules, engines, and data stores are somewhat arbitrary, and particular operations are illustrated in a context of specific illustrative configurations. Other allocations of functionality are envisioned and may fall within a scope of various embodiments of the present disclosure. In general, structures and functionality presented as separate resources in the example configurations may be implemented as a combined structure or resource. Similarly, structures and functionality presented as a single resource may be implemented as separate resources. These and other variations, modifications, additions, and improvements fall within a scope of embodiments of the present disclosure as represented by the appended claims. The specification and drawings are, accordingly, to be regarded in an illustrative rather than a restrictive sense.

What is claimed is:

1. A method comprising:
identifying, by a processor of a machine, a set of items in a product cluster in a marketplace, the set of items comprising a plurality of items having one or more shared characteristics;
determining an average price of the set of items;
identifying, for a retailer other than the marketplace, an average price of items available for sale by the retailer, the items available for sale by the retailer corresponding to the product cluster;
determining whether the average price of the set of items is lower than the average price of items available for sale by the retailer; and
in accordance with the determination, generating a recommendation for the marketplace.

2. The method of claim 1, wherein:
the average price of the set of items is lower than the average price of items available for sale by the retailer; and
the method further comprises, in accordance with the determination:
causing a display of a promotion for an item in the set of items.

3. The method of claim 1, wherein:
the average price of the set of items is lower than the average price of items available for sale by the retailer; and
the method further comprises, in accordance with the determination:
identifying a seller in the marketplace of an item in the set of items; and
sending a message to the seller that encourages the seller to provide additional items in the product cluster for sale.

4. The method of claim 1, wherein:
the average price of the set of items is higher than the average price of items available for sale by the retailer; and
the method further comprises, in accordance with the determination:
identifying an item in the set of items that is not one of the items available for sale by the retailer; and
causing a display of a promotion for the item in the set of items that is not one of the items available for sale by the retailer.

5. The method of claim 1, wherein:
the average price of the set of items is higher than the average price of items available for sale by the retailer; and
the method further comprises, in accordance with the determination:
identifying a seller in the marketplace of an item in the set of items; and
sending a message to the seller that encourages the seller to reduce a price of the item.

6. The method of claim 1, wherein the one or more shared characteristics of the set of items are selected from the group comprising text strings in titles, text strings in descriptions, images, catalog data, current price, starting price, and buy-it-now price.

7. The method of claim 1, wherein the one or more shared characteristics of the set of items comprise text strings in titles, text strings in descriptions, images, catalog data, current price, starting price, and buy-it-now price.

8. The method of claim 1, further comprising:
determining a degree of variety for a series of items viewed by a user; and
based on the degree of variety and a threshold:
identifying an item in the set of items that is not one of the items available for sale by the retailer; and
causing a display of a promotion for the item in the set of items that is not one of the items available for sale by the retailer.

9. The method of claim 1, further comprising:
determining a degree of variety for a series of items viewed by a user; and
based on the degree of variety and a threshold:
causing a display of a promotion for an item in the set of items.

10. A system comprising:
a memory that stores instructions; and
one or more processors configured by the instructions to perform operations comprising:
identifying a set of items in a product cluster in a marketplace, the set of items comprising a plurality of items having one or more shared characteristics;
determining an average price of the set of items;
identifying, for a retailer other than the marketplace, an average price of items available for sale by the retailer, the items available for sale by the retailer corresponding to the product cluster;
determining whether the average price of the set of items is lower than the average price of items available for sale by the retailer; and
in accordance with the determination, generating a recommendation for the marketplace.

11. The system of claim 10, wherein:
the average price of the set of items is lower than the average price of items available for sale by the retailer; and
the operations further comprise:
in accordance with the determination, causing a display of a promotion for an item in the set of items.

12. The system of claim 10, wherein:
the average price of the set of items is lower than the average price of items available for sale by the retailer; and
the operations further comprise:
in accordance with the determination, identifying a seller in the marketplace of an item in the set of items; and
sending a message to the seller that encourages the seller to provide additional items in the product cluster for sale.

13. The system of claim 10, wherein:
the average price of the set of items is higher than the average price of items available for sale by the retailer; and
the operations further comprise:
in accordance with the determination, identifying an item in the set of items that is not one of the items available for sale by the retailer; and
causing a display of a promotion for the item in the set of items that is not one of the items available for sale by the retailer.

14. The system of claim 10, wherein:
the average price of the set of items is higher than the average price of items available for sale by the retailer; and
the operations further comprise:
in accordance with the determination, identifying a seller in the marketplace of an item in the set of items; and
sending a message to the seller that encourages the seller to reduce a price of the item.

15. The system of claim 10, wherein the one or more shared characteristics of the set of items are selected from the group comprising text strings in text strings in descriptions, images, catalog data, current price, starting price, and buy-it-now price.

16. The system of claim 10, wherein the one or more shared characteristics of the set of items comprise text strings in titles, text strings in descriptions, images, catalog data, current price, starting price, and buy-it-now price.

17. The system of claim 10, further comprising:
determining a degree of variety for a series of items viewed by a user; and
based on the degree of variety and a threshold:
identifying an item in the set of items that is not one of the items available for sale by the retailer; and
causing a display of a promotion for the item in the set of items that is not one of the items available for sale by the retailer.

18. The system of claim 10, further comprising:
determining a degree of variety for a series of items viewed by a user; and
based on the degree of variety and a threshold:
causing a display of a promotion for an item in the set of items.

19. A machine-readable medium not having any transitory signals and having instructions embodied thereon which, when executed by one or more processors of a machine, cause the machine to perform operations comprising:
identifying a set of items in a product cluster in a marketplace, the set of items comprising a plurality of items having one or more shared characteristics;
determining an average price of the set of items;
identifying, for a retailer other than the marketplace, an average price of items available for sale by the retailer, the items available for sale by the retailer corresponding to the product cluster;
determining whether the average price of the set of items is lower than the average price of items available for sale by the retailer; and
in accordance with the determination, generating a recommendation for the marketplace.

20. The machine-readable medium of claim 19, wherein:
the average price of the set of items is lower than the average price of items available for sale by the retailer; and
the operations further comprise:
in accordance with the determination, causing a display of a pro motion for an item in the set of items.
